(19) United States
(12) Patent Application Publication
(10) Pub. No.: US 2010/0144513 A1
(43) Pub. Date: Jun. 10, 2010

(54) Catalyst for Olefin Upgrading

(76) Inventors: Christopher P. Nicholas, Evanston, IL (US); Laszlo T. Nemeth, Barrington, IL (US); Deng-Yang Jan, Elk Grove Village, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/330,540

(22) Filed: Dec. 9, 2008

(51) Int. Cl. B01J 29/70

(52) U.S. Cl. 502/68; 502/60; 502/64

(57) ABSTRACT

A catalyst, and the process for producing the catalyst, for use in the oligomerization of olefins is presented. The catalyst comprises a zeolite that is treated with a phosphorous containing reagent to generate a treated catalyst having phosphorous content between 0.5 and 15 wt % and a micropore volume of less than 50% of the untreated catalyst.

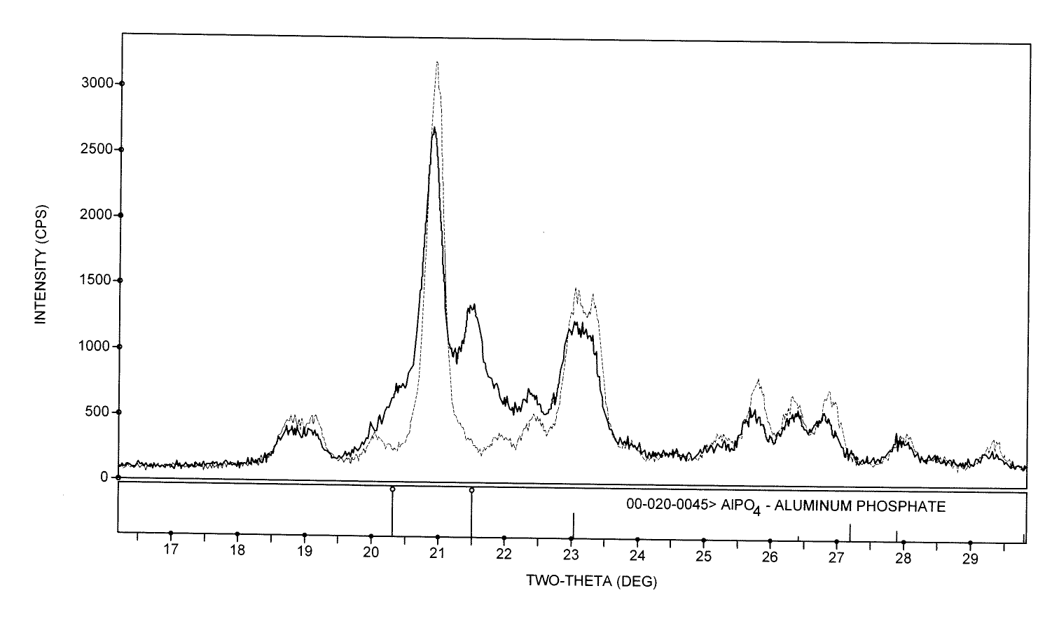

### FIELD OF THE INVENTION

This invention relates to solid catalysts for the transformation of hydrocarbons. In particular, this invention relates to solid catalysts that oligomerize light olefins to olefins in the gasoline range.

### BACKGROUND OF THE INVENTION

The oligomerization of light olefins, such as propylene and butenes, to produce higher carbon number olefins, or olefins having 5 or more carbons is known. The oligomerization process is used for the production of high quality motor fuel from low molecular weight olefins. Oligomerization is also referred to as a catalytic condensation process with a resulting motor fuel often referred to as polymer gasoline. Methods have been sought to improve the quality of gasoline, and in particular the octane number of the gasoline. This octane enhancement is realized through the improvement in reaction selectivity to enhance the amount of high octane blending components as a result of increasing the amount of branched olefins. Polymer gasoline has the benefit of also being a low aromatic content gasoline.

The current state of the conversion of light hydrocarbons to high octane motor fuels involves the use of strong acid catalysts, such as hydrofluoric acid (HF) catalyst, for the alkylation of light paraffins with olefins. This is commonly referred to as HF alkylation. While HF alkylation has a long history in the production of high octane motor fuels, HF alkylation has significant handling issues, and safety concerns due to the nature of hydrofluoric acid. One alternative is sulfuric acid, but this also present issues, and is also a homogeneous catalytic reaction that requires special handling.

The oligomerization process is often combined with other hydrocarbon transformation processes. Other processes include saturation and dehydrogenation. Patents disclosing the dehydrogenation of light paraffins with oligomerization of the olefinic effluent stream include U.S. Pat. No. 4,393,259, U.S. Pat. No. 5,049,360, U.S. Pat. No. 4,749,820, U.S. Pat. No. 4,304,948, and U.S. Pat. No. 2,526,966.

Hydrotreating of olefinic streams to saturate the olefins to produce a high octane fuel is also known. The oligomerization and hydrogenation of a C4 fraction to produce a jet fuel is disclosed in GB 2,186,287, and which also discloses the optional hydrogenation into a premium gasoline. U.S. Pat. No. 4,678,645 discloses the hydrotreatment of jet fuels, diesel fuels and lubricants that have been produced by dehydrogenation and oligomerization of light paraffins. However, hydrotreating of gasoline produced by oligomerization can reduce octane numbers of the gasoline, while saturating olefins to paraffins.

Other known catalysts for effecting oligomerization include heterogeneous catalysts such as boron trifluoride as described in U.S. Pat. No. 3,981,941, or catalysts that are mild protonic acids, generally having a Hammett acidity function of less than −5.0. Particularly preferred are solid phosphoric acid (SPA) catalysts having as a principal ingredient an acid of phosphorous such as ortho, pyro, or tetraphosphoric acid. SPA catalysts can be found in U.S. Pat. No. 5,895,830.

The use of zeolites for oligomerization, and particularly the use of zeolites having medium pores, is also described in the patent literature. U.S. Pat. No. 4,547,613 uses a ZSM-5 type catalyst that has been conditioned at low pressure and high temperature with a light hydrocarbon gas. A process for producing lubricating oils from the conversion of light olefins using the ZSM-5 catalyst is disclosed in U.S. Pat. No. 4,520,221. Other intermediate pore zeolites are disclosed in U.S. Pat. No. 4,642,404 and U.S. Pat. No. 5,284,989.

While work has indicated that zeolites can be used for the oligomerization of olefins, prior use of zeolites produce a poor quality product for use as a gasoline.

### SUMMARY OF THE INVENTION

The present invention provides for an improved catalyst for use in the oligomerization of olefins. The new catalyst overcomes the problem of the production of excess heavies. The catalyst comprises a molecular sieve and a binder. The catalyst is treated with a phosphorous reagent, thereby forming a treated catalyst, wherein the resulting treated catalyst has a micropore volume less than 50%, and a crystallinity greater than 50% of the untreated catalyst. The phosphorus reagent can be selected from a phosphate compound, such as phosphoric acid (H₃PO₄), ammonium phosphate (NH₄H₂PO₄), or diammonium phosphate ((NH₄)₂HPO₄), with a preferred phosphate compound being phosphoric acid. Other phosphorous containing reagents include triphenyl phosphine, trialkyl phosphines, trialkyl phosphites, and phosphorous oxytrichloride.

In another embodiment, the invention comprises methods of producing a catalyst for use in the oligomerization of olefins. The method comprises forming a molecular sieve into molecular sieve pellets. The molecular sieve is preferably selected from zeolites having a structure from the following structure types: MFI, MEL, ITH, IMF, TUN, FER, BEA, FAU, BPH, MEI, MSE, MWW, UZM-8, MOR, OFF, MTW, TON, MTT, AFO, ATO, or AEL. The molecular sieve pellets are treated with a phosphorous reagent treatment, thereby generating a treated molecular sieve. The method is carried out under conditions until the treated catalyst has a phosphorous component between 0.5 and 15 wt %. The treated catalyst from the process further has a micropore volume of less than 50% of, and a crystallinity greater than 50% of the untreated catalyst.

Other objects, advantages and applications of the present invention will become apparent to those skilled in the art from the following detailed description and FIGURE.

### BRIEF DESCRIPTION OF THE FIGURE

FIGURE is an x-ray diffraction pattern of the catalyst of example 1 (dashed line) and example 4 (solid line) showing the transformation of Al₂O₃ binder to AlPO₄.

### DETAILED DESCRIPTION OF THE INVENTION

Currently, solid phosphoric acid (SPA) is used in the oligomerization of olefins, and in the alkylation of benzene. SPA is inexpensive and well known, however, it is exceedingly difficult to remove from reactors and is non-regenerable. Therefore, it is desirable to have a regenerable catalyst, and one that is easy to remove from reactors. In the alkylation of benzene, some zeolite based solid catalysts have shown superior performance and life of the catalyst. However, there have been no zeolite materials employed in the commercial scale for the oligomerization of olefins.

The main problem with the use of many zeolites as solid acid replacements for SPA catalysts involves the undesirable production of heavy products. With the oligomerization of olefins, this is a severe problem, especially in the production of hydrocarbons for use in gasoline. With the production of heavies that are generated in the oligomerization process, the heavies go into the gasoline pool and create a poorer gasoline product such as poor drivability.

A solid catalyst for replacing SPA catalyst has been invented, where the catalyst comprises a molecular sieve and a binder. The catalyst is treated with a phosphorous containing reagent to form a treated catalyst that has a micropore volume less than 50% of the untreated catalyst. A micropore volume is the pore volume for pore openings less than approximately 10 Å. The catalyst is further defined as having a crystallinity after treatment to be greater than 50% of the untreated catalyst as measured by X-ray diffraction technique. The catalyst, before treatment, will preferably have an initial micropore volume of at least 0.05 ml N₂/g, as measured by standardized BET adsorption theory.

Zeolites can be used for oligomerization, and zeolites are more active than SPA for the oligomerization process. The drawback for using zeolites is the increased activity generates a product that contains significant amounts of heavier components with boiling points exceeding gasoline end point specification, or a poorer product. This increases the final boiling point of the product to typically greater than 225° C. The present invention provides for a catalyst that has been treated to modulate the activity of the catalyst and to limit the production of heavies. After treatment of the zeolitic catalyst, the liquid product produced over the catalyst contained only 3 wt % material with a boiling point greater than 225° C. This is comparable to SPA catalyst performance.

The phosphorous treatment of the catalyst produced other benefits. The amount of coking on the catalyst decreased by a factor of 10. This increases the cycle time for operating an oligomerization reactor between catalyst regeneration stages. An important use of the oligomerization of olefins is the production of high octane gasoline, as measured by the octane number, with low aromatic components, or the production of high octane gasoline components for blending with other gasoline. The SPA catalyzed oligomerization produces a product having a research octane number of 98. The product produced by the catalyst of the present invention has a research octane number of 99.

The molecular sieve is preferred to be a zeolite, and where the zeolite comprises between 5 and 95 wt % of the catalyst. Preferred zeolites include zeolites having a structure from one of the following classes: MFI, MEL, ITH, IMF, TUN, FER, BEA, FAU, BPH, MEI, MSE, MWW, UZM-8, MOR, OFF, MTW, TON, MTT, AFO, ATO, and AEL. A most preferred catalyst is MTW.

The catalyst is formed by combining the molecular sieve with a binder, and then forming the catalyst into pellets. The pellets are then treated with a phosphoric reagent to create a molecular sieve having a phosphorous component between 0.5 and 15 wt % of the treated catalyst. This generates a catalyst having a micropore volume less than 50% of the initial micropore volume, while retaining a crystallinity of greater than 50% of the untreated catalyst.

The binder is used to confer hardness and strength on the catalyst. Binders include Al₂O₃, AlPO₄, SiO₂, silica-alumina, ZrO₂, TiO₂, combinations of these metal oxides, and other refractory oxides, and clays such as montmorillonite, kaolin, palygorskite, smectite and attapulgite. A preferred binder is an aluminum based binder, such as Al₂O₃, AlPO₄, silica-alumina and clays, wherein a portion of the binder is converted to AlPO₄ during the phosphorous treatment process.

The phosphorous reagent is preferably a phosphate compound, and is preferably selected from phosphoric acid (H₃PO₄), ammonium phosphate (NH₄H₂PO₄), and diammonium phosphate ((NH4)₂HPO₄). A most preferred compound is phosphoric acid. Other phosphorous containing reagents include triphenyl phosphine, trialkyl phosphines, trialkyl phosphites, and phosphorous oxytrichloride. The catalyst is contacted with the phosphorous containing reagent for a treatment time between 1 hour and 10 hours. The treatment is run for a sufficient time to achieve a phosphorous level between 0.5 and 15 wt % of the treated catalyst. Preferably, the phosphorous level is between 5 and 12 wt % of the treated catalyst.

The catalyst is treated with the phosphorous reagent at a temperature between 20° C. and 100° C., and preferably at a temperature between 60° C. and 80° C. The treated catalyst is then subjected to a calcining treatment at a temperature greater than 300° C.

The catalyst formed preferably comprises a one-dimensional molecular sieve. A one-dimensional molecular sieve contains non-intersecting pores that are substantially parallel to one of the axes of the crystal. The pores preferably extend through the zeolite crystal. The pores preferably are comprised of either 10 or 12 membered rings.

In a preferred embodiment, the catalyst comprises a zeolite having an MTW structure, which when treated with a phosphorous reagent produces a catalyst that, when used in olefin oligomerization, generates a high quality product having a low heavies selectivity.

In an alternate embodiment, the catalyst can be produced by treating the zeolite with a phosphorous reagent to create a zeolite having a phosphorous content between 0.5 and 15 wt % of the treated zeolite. The treated zeolite is then mixed with a binder, and then formed into pellets. The pellets are then calcined to harden the pellets and drive off any water, thereby creating the treated catalyst.

TABLE 1
Product Selectivity

| | | | | | 10% P |
|---|---|---|---|---|---|
| | | | | 70/30 | H₃PO₄ |
| Catalyst/ | | 80/20 | 10% P H₃PO₄ | UZM- | UZM-8/ |
| selectivity | SPA | MTW/Al₂O₃ | MTW/Al₂O₃ | 8/Al₂O₃ | Al₂O₃ |
| C5 selectivity | 1.3 | 0.3 | 0 | 0.8 | 0.5 |
| C6 selectivity | 7.9 | 2.2 | 0.4 | 2.1 | 1.5 |
| C7 selectivity | 33.0 | 25.6 | 14.0 | 15.6 | 18.6 |
| C8 selectivity | 23.4 | 23.3 | 24.1 | 21.9 | 25.2 |
| C9/C10 select. | 23.9 | 16.3 | 4.9 | 16.2 | 12.1 |
| C10-12 select. | 7.5 | 17.3 | 53.6 | 13.4 | 20.1 |
| Heavies select. | 3.0 | 15.0 | 3.0 | 30.0 | 22.0 |

The results in Table 1, show the product selectivity for the new phosphorous treated catalyst as compared with the untreated catalyst. The product from the SPA catalyst is included for comparison. The phosphorous treated catalyst shows a decline in the heavies content over the untreated catalyst. When the catalyst is MTW/Al₂O₃, the heavies content decreased to be comparable with the heavies content of the SPA catalyst. There was also a shift in selectivities with the phosphorous treated catalyst. There was an increase in branched C12 compounds, in particular triisobutylene. Branched alkenes are good for increasing octane numbers. In addition, utilizing the phosphorous treated catalyst causes a reduction in the selectivity to the C5 fraction of the gasoline. It is beneficial to minimize the amount of C5 and C6 compounds in the gasoline pool due to the increase in Reid vapor pressure they cause.

A sample of alumina bound MTW extrudate of 1/16″ diameter was treated with phosphoric acid. A solution was made using 27.5 gm of 85% H₃PO₄ with 485.7 gm of deionized water in a flask. A sample comprised 57 gm of alumina bound MTW extrudate was added to the flask, and the flask was attached to a rotary evaporator. The molecular sieve was reacted with the phosphoric acid solution at 70° C. and the flask was rotated until most of the interstitial liquid was gone. A 10% P on MTW zeolite was obtained.

The MTW extrudate included an alumina binder. The catalyst, after treatment with phosphoric acid was then calcined at 350° C. to drive off any residual water. The extrudate was formed as 1/16″ extrudate pellets.

The phosphorus treated zeolite was loaded into a steel reactor, and a process stream was passed over the catalyst at reaction conditions to form a gasoline product. The process stream was a 50:50 mixture of C3 and C4, with the olefin to paraffin ratio equal to 50:50 for both C3 and C4. The reactor was operated at 3.5 MPa (500 psi) with weight hourly space velocities (WHSV) between 1.0 and 5.0 hr⁻¹. The temperature for the reaction in the bed was between 110° C. and 130° C., but because the reaction is exothermic, the furnace temperature is usually 10-20° C. less. The choice of feedstock for the process stream is simply a model feedstock that is similar to many feeds for commercial units that use SPA catalyst, and not intended to be limiting. Other feedstocks containing light olefins can also be used.

Example 1. A sample of MTW zeolite was bound with Al₂O₃ at 80/20 ratio. Example 2. The catalyst of Example 1 was treated with H₃PO₄ to give a catalyst containing 1 wt % P. Example 3. The catalyst of Example 1 was treated with H₃PO₄ to give a catalyst containing 5 wt % P. Example 4. The catalyst of Example 1 was treated with H₃PO₄ to give a catalyst containing 10 wt % P. Example 5. The catalyst of Example 1 was treated with (NH₄)H₂PO₄ to give a catalyst containing 10 wt % P. Example 6. A sample of UZM-8 was bound with Al₂O₃ at 70/30 ratio. Example 7. The catalyst of Example 6 was treated with H₃PO₄ to give a catalyst containing 10 wt % P. Example 8. A sample of MTT zeolite was bound with Al₂O₃ at 80/20 ratio. Example 9. The catalyst of Example 8 was treated with H3PO4 to give a catalyst containing 10 wt % P.

TABLE 2
Catalyst Characterization

| | | N₂ Pore Vol. | Relative | P content |
|---|---|---|---|---|
| Catalyst | BET SA (m²/g) | (mL/g) | Crystallinity | (wt %) |
| Example 1. | 280 | 0.368 | Reference | 0 |
| Example 2. | 244 | 0.333 | 91 | 1 |
| Example 3. | 117 | 0.163 | 76 | 5 |
| Example 4. | 25 | 0.069 | 86 | 10.1 |
| Example 5. | 28 | 0.063 | 72 | 10.2 |
| Example 6. | 424 | 0.728 | Reference | 0 |
| Example 7. | 122 | 0.302 | N/A | 11.2 |
| Example 8. | 129 | 0.319 | Reference | 0 |
| Example 9. | 15 | 0.072 | 64 | 10.1 |

One can see from Examples 1-4 that after treating a MTW catalyst to between 5 and 12wt % phosphorous content with H₃PO₄ that surface area and micropore volume of the catalyst are decreased to less than 50% of the initial value, while unexpectedly retaining >50% of crystallinity relative to the catalyst of example 1. Example 1 catalyst has an N₂ micropore volume of 0.07 mL/g, and example 4 catalyst has an N₂ micropore volume of 0.005 mL/g as determined by t-plot analysis of the N₂ BET data. By comparing examples 1, 4 and 5, one can see that varying the phosphorous reagent at constant phosphorous content has a secondary effect on both surface area and relative crystallinity. In examples 8 and 9, another 1-dimensional zeolite, MTT, is studied. Treating the catalyst of example 8 with H₃PO₄ causes a reduction in surface area and pore volume while retaining zeolite crystallinity. Examples 6 and 7 show the effect of the same treatment on a multi-dimensional zeolite, UZM-8. Treatment of a UZM-8 catalyst also shows greater than 50% reduction in surface area and pore volume while retaining greater than 50% crystallinity relative to the untreated sample.

The x-ray diffraction pattern of the catalyst of example 1 and example 4 are presented in the FIGURE. The overall crystallinity was not affected significantly by the incorporation of phosphorus. As can be seen by the appearance of the peaks at d=4.370 Å and 4.130 Å in the catalyst of example 4, a portion of the Al₂O₃ binder is converted to AlPO₄ during the phosphorous treatment.

An MTW zeolite was used for oligomerization, but produced a product comprising 15 wt. % heavies. The heavies having a boiling point greater than 225° C. are undesirable for a gasoline product. Utilizing a P treated MTW zeolite to moderate the catalyst activity, and to reduce the heavies production, the oligomerization process was run. The results from the oligomerization using the P treated zeolite generated only 3 wt. % heavies. A significant improvement over the untreated zeolite.

While the invention has been described with what are presently considered the preferred embodiments, it is to be understood that the invention is not limited to the disclosed embodiments, but it is intended to cover various modifications and equivalent arrangements included within the scope of the appended claims.

1. A catalyst for use in the transformation of hydrocarbons, comprising:
a molecular sieve and a binder, wherein the catalyst has been treated with a phosphorous containing reagent, thereby forming a treated catalyst having a micropore volume less than 30%, and a crystallinity greater than 50% of the untreated catalyst.

2. The catalyst of claim 1 wherein the molecular sieve is a zeolite.

3. The catalyst of claim 2 wherein the zeolite comprises between 5 and 95 wt. % of the catalyst.

4. The catalyst of claim 2 wherein the zeolite contains 10 or 12 membered rings.

5. The catalyst of claim 4 wherein the zeolite has a structure type selected from the group consisting of MFI, MEL, ITH, IMF, TUN, FER, BEA, FAU, BPH, MEI, MSE, MWW, UZM-8, MOR, OFF, MTW, TON, MTT, AFO, ATO, AEL, and mixtures thereof.

6. The catalyst of claim 5 wherein the zeolite is UZM-8.

7. The catalyst of claim 5 wherein the zeolite comprises non-intersecting pores that are substantially parallel to one of the axes, and extend through the zeolite crystal.

8. The catalyst of claim 7 wherein the pores are comprised of either 10 or 12 membered rings.

9. The catalyst of claim 7 wherein the zeolite has an MTW structure.

10. The catalyst of claim 1 wherein the phosphorous containing reagent is a phosphate.

11. The catalyst of claim 10 wherein the phosphate is selected from the group consisting of phosphoric acid (H₃PO₄), ammonium phosphate (NH₄H₂PO₄), diammonium phosphate ((NH₄)₂HPO₄), and mixtures thereof.

12. The catalyst of claim 11 wherein the phosphorous containing reagent is phosphoric acid.

13. The catalyst of claim 1 wherein the phosphorous containing reagent is selected from the group consisting of triphenyl phosphine, trialkyl phosphines, trialkyl phosphites, phosphorous oxytrichloride, and mixtures thereof.

14. The catalyst of claim 1 wherein the binder material is selected from the group consisting of Al₂O₃, AlPO₄, SiO₂, silica-alumina, ZrO₂, TiO₂, montmorillonite, kaolin, palygorskite, smectite, attapulgite, and mixtures thereof.

15. (canceled)

16. The catalyst of claim 14 wherein the binder material is alumina.

17. The catalyst of claim 16 wherein a portion of the binder material is converted to AlPO₄ during the phosphorous treatment process.

18. The catalyst of claim 1 wherein the catalyst has an initial micropore volume of the untreated catalyst is greater than 0.05 mL N₂/g catalyst as measured by BET.

19. The catalyst of claim 1 wherein the phosphorous content of the treated catalyst is between 0.5 and 15 wt. %.

20. The catalyst of claim 19 wherein the phosphorous content of the treated catalyst is between 5 and 12 wt %.
